(19) United States
(12) Patent Application Publication
(10) Pub. No.: US 2012/0249460 A1
(43) Pub. Date: Oct. 4, 2012

(54) INPUT DEVICE AND INPUT METHOD FOR ELECTRONIC EQUIPMENTS

(75) Inventors: Kosuke MIZUTANI, Kitasaku-gun (JP); Tsunehisa KOBAYASHI, Kitasaku-gun (JP); Takamichi KITANO, Kitasaku-gun (JP)

(73) Assignee: MINEBEA CO., LTD., Kitasaku-gun (JP)

(21) Appl. No.: 13/432,620

(22) Filed: Mar. 28, 2012

(30) Foreign Application Priority Data
Mar. 31, 2011 (JP) 2011-080296

(51) Int. Cl. G06F 3/041

(52) U.S. Cl. 345/173

(57) ABSTRACT

An input device for an electronic equipment includes: an input operation surface; an operation unit with a touch sensor detecting input operation on the input operation surface; and a control circuit unit to which detected signals from the touch sensor arranged in the operation unit are input. The input operation surface has at least one coordinate thereon; the control circuit unit includes a first decision information deciding a start of the input operation to a position designated by the coordinate based on a first regulation of the detected signals; the control circuit unit also includes a second decision information deciding a termination of the input operation to a position designated by the coordinate based on a second regulation of the detected signals; and presence of the input operation to the input operation surface is determined based on the decision of the start and the termination of the input operation.

### BACKGROUND OF THE INVENTION

1. Field of the Invention

The present invention relates to an input device and an input method for electronic equipments, especially to an input device and an input method for electronic equipments, which certainly determine actual input operations to be executed by operators.

2. Description of the Related Art

Considering recent input devices for electronic equipments, input devices, by which input operations are detected through a touch sensor, have been widely used. In the input operations, each operator will touch his or her finger(s) on an input operation surface. In these types of the input devices, the detection of the input operations are generally performed based on a comparison between detected signals from the touch sensor and predetermined threshold values. Since the detected signals from the touch sensor are easily subjected to some alterations due to the influence of some environmental changes, a variety of technologies that can prevent false detections caused thereby have been proposed so far. See, for example, Japanese Patent Application Laid-open No. 2009-169697 (hereinafter referred to as the “Patent Document”).

In a device disclosed in the Patent Document, threshold values, that is, references to detect input operations, are periodically updated based on the moving average of detected signals from a touch sensor. Accordingly, the device is designed to determine a difference between relatively rapid changes of the detected signals (input operations) and relatively slow changes of the detected signals (some environmental changes).

However, factors that influence the detected signals output from the touch sensor are not limited only to the environmental changes. For example, like input devices such as a keyboard for a personal computer where relatively the large numbers of key switches are present on an input operation surface, and where operators perform input operations with their fingers (usually by both hands) at high speeds to each of the key switches, it is preferable to allow operators to have the following pose for keeping good operationabilities. That is, while operators are performing input operations, a part of their hands or their whole hands including fingers which either perform or not perform the input operations to specific key switches are allowed to touch or to be near the input operation surface (hereinafter referred to as the “stand-by pose”).

In any input devices using such a touch sensor, in order to achieve the above operationability, it is strongly desired that the input device is allowed to determine (or differentiate) the following based on detected signals output from the touch sensor: 1) Operators touch their fingers, etc. to the input operation surface, or reach their fingers, etc. near the input operation surface for input operations with their intention; and 2) Operators, due to the stand-by pose, touch their fingers, etc. to the input operation surface, or reach their fingers, etc. near the input operation surface without their intention for input operations.

On the contrary, considering the method disclosed in the Patent Document where threshold values are updated based on the moving average of detected signals from the touch sensor, it could be difficult to determine the variation of the detected signals induced by the stand-by pose. In addition, since the variation of the detected signals is configured to reflect to the updating of the threshold values, it may deteriorate the detectivity of input operations to be actually performed by operators.

Further, in the method of the Patent Document, during input operations, threshold values are updated due to the moving average of detected signals. Accordingly, when the detection of the input operations includes not only the detection of start (transition from the OFF condition to the ON condition) but also the detection of termination (transition from the ON condition to the OFF condition), it may deteriorate the detectivity of the termination of the input operations. For example, when a key switch is pressed for a certain extended period of time (hereinafter referred to as the “long-pressed condition”), in the comparison of the threshold values to be updated during the long-pressed condition, it may determine that the input operations have been terminated although operators have been continuously performing the input operations.

### SUMMARY OF THE INVENTION

The present invention has been made in light of the above problems, and it is an object of the present invention to provide an input device for electronic equipments that can certainly determine input operations executed by operators with no influence due to variations of detected signals induced by many factors.

Embodiments according to the present invention hereinbelow exemplify some structures of the present invention, and are itemized for facilitating understanding of various structures of the present invention. Each item does not intend to limit the technical scope of the present invention. While considering the best modes to carry out the present invention, even if components of each item is partially substituted or deleted, or even if another component is added thereto, these should be regarded as the elements of the technical scope of the present invention.

In order to achieve the object described above, according to a first aspect of the present invention, there is provided an input device for an electronic equipment, the input device being composed of: an input operation surface; an operation unit including a touch sensor that detects input operation on the input operation surface; and a control circuit unit to which detected signals output from the touch sensor arranged in the operation unit are input, wherein the input operation surface has at least one coordinate thereon; the control circuit unit includes a first decision information that decides a start of the input operation to a position designated by the coordinate based on a first regulation of the detected signals; the control circuit unit also includes a second decision information that decides a termination of the input operation to a position designated by the coordinate based on a second regulation of the detected signals; and presence of the input operation to the input operation surface is determined based on the decision of the start and the termination of the input operation.

In the input device thus structured, the control circuit unit is provided at each of the at least one coordinate arranged on the input operation surface. The control circuit unit will determine presence of the input operations to the input operation surface based on: 1) the regulation of the detected signals of the touch sensor (that is, the ratio of variation at a predetermined time); and 2) the determination of the start and the termination of input operations through the first and second decision information. Accordingly, even if the size of the detected signals varies due to the factors other than operators' intention of inputting information to the input device (hereinafter referred to as the “actual input operations”), it can effectively differentiate between the variation of detected signals due to the actual input operations and the variation of the detected signals due to other factors. It is thus allowed to prevent any false detection when determining the presence of input operations.

Here, throughout this specification, the term “coordinate” on the input operation surface in the input device means optional information used to designate any specific positions (or ranges) on which input operations are performed. This may include data corresponding to values (or the ranges of the values) that have been actually readable from an optional two-dimensional coordinate provided on the input operation surface. However, the term “coordinate” is not limited thereto. For example, in case that there are a plurality of, but individually provided partitions on the input operation surface of the input device, the partitions defining a position, on which each of the input operations is performed (typically, in a case that an individual switch corresponding to each of the partitions is provided), optional information that has a one-to-one correspondence to each of the partitions and that can define each of the partitions may be called as the “coordinate.” The “coordinate” explained hereinabove may include, for example, integer serial numbers, or integer set of numbers given to each of the partitions.

In the first aspect of the present invention, the first decision information includes a first reference value of the first regulation; the second decision information includes a second reference value of the second regulation; and the control circuit unit is composed of a memory unit that stores the first and the second reference values to each of the at least one coordinate, and a data processing unit that determines presence of the input operation at each coordinate, the data processing unit being configured to work as follows: 1) both the first regulation and the second regulation are applied to determine as an average regulation at a predetermined time of the detected signals that have been input to the control circuit unit; 2) the first reference value to the coordinate corresponding to the detected signals is compared with the first regulation, and when a result that is determinable as the start of the input operation is obtained at least one time based on the comparison, decision, in which the input operation to a position designated by the coordinate starts, is determined; and 3) the second reference value and the second regulation of the coordinate corresponding to the detected signals are compared to each other, and when a result that is determinable as the termination of the input operation is obtained at least one time based on the comparison, decision, in which the input operation to a position designated by the coordinate terminates, is determined.

In the input device thus structured, the device comprises the memory unit that memorizes the first and the second reference values based on the regulation of the detected signals, and the data processing unit that determines the start and the termination of the input operations at each of the coordinates. In the data processing unit, the first and the second regulations are determined as an average regulation at a predetermined time of the detected signals that have been input to the control circuit unit. Further, based on a comparison between the first regulation and the first reference value, and based on a comparison between the second regulation and the second reference value, the start and the termination of the input operations will be determined. Accordingly, by optionally setting the predetermined time, the first and the second reference values, and the number of decisions necessary to determine the start and the termination of input operations, it will make possible to effectively differentiate the following elements by a simplified and low-cost structure so as to prevent false detections when determining the presence of input operations. The above elements are 1) variation of the detected signals induced by factors that are widely selectable and that occur at various time scales, and 2) variation of the detected signals induced by the actual input operations.

Here, the variation of the detected signals that occur at various time scales may include: 1) variation which is more rapid than the one induced by the actual input operations due to, for example, high frequency noises; and 2) variation which is more moderate than the one of the actual input operations that occur by, for example, environmental changes, or what operators touch their fingers, etc. onto the input operation surface, or reach their fingers, etc. near the input operation surface with no intention of the actual input operations.

Further, as described hereinabove, this input device can effectively differentiate between 1) variation of the detected signals by which operators touch their fingers, etc. onto the input operation surface, or reach their fingers, etc. near the input operation surface without intention of the actual input operations; and 2) variation of detected signals due to the actual input operations. Accordingly, the operators working on this input device are allowed to take the stand-by pose while performing the input operations. With this structure, the operationability of the input device is improved. The improvement of such operationability will be especially benefit in input devices (for example, key board devices for a personal computer) where the relatively large number of coordinates are arranged on the input operation surface, and where operators are expected to perform input operations to each of the coordinates at high speeds with fingers.

In the first aspect of the present invention, there is provided an input device according to claim 2, wherein the control circuit unit performs the following operation to each of the at least one coordinate provided on the input operation surface: 1) from a decision where the input operation to the coordinate starts to a decision where the input operation to the coordinate terminates, the input operation to the coordinate is determined as being present; and 2) from a decision where the input operation to the coordinate terminates to a decision where the input operation to the coordinate starts, the input operation to the coordinate is determined as being not present.

In the input device thus structured, it makes possible to effectively determine between variation of the detected signals by the actual input operations and variation of detected signals induced by various factors which do not arise from the actual input operations. Here, even if a condition being in the presence of input operations is kept for a considerable period of time (for example, a key has been pressing for a certain period), detection can be certainly performed without deteriorating detectivity of the input operations.

In the first aspect of the present invention, the control circuit unit is configured as that the first and the second reference values to the at least one coordinate provided on the input operation surface are allowed to be set to the whole coordinate uniformly or to each coordinate individually, and the data processing unit performs at least one of the following operation: 1) when determining that an input operation to at least one of the coordinates has started, the first reference value is reset so as to update the whole coordinate uniformly or each coordinate individually according to a size of the first regulation of the detected signals based on the determination; and 2) when determining that an input operation to at least one of the coordinates has terminated, the second reference value is reset so as to update the whole coordinate uniformly or each coordinate individually according to a size of the second regulation of the detected signals based on the determination.

In the input device thus structured, when the presence of input operations to the input operation surface is determined, the first decision information and the second decision information are to be updated on the whole coordinate uniformly or be updated at each coordinate individually according to the size of the first and the second regulations of the input detected signals. Accordingly, while being activated, the detectivity of variations of the detected signals corresponding to the actual input operations, and determination accuracy to variations of the detected signals induced by the other factors other than the actual input operations will be always kept in proper conditions.

In a second aspect of the present invention, there is provided an input method of an input device for an electronic equipment, the input device being composed of: an input operation surface; an operation unit including a touch sensor that detects input operation to the input operation surface; and a control circuit unit to which detected signals of the touch sensor in the operation unit is input, the input method comprising the following step in each of at least one coordinate arranged on the input operation surface: 1) determining a start of an input operation to a position designated by the at least one coordinate arranged on the input operation surface based on a first regulation of the detected signals; 2) determining a termination of the input operation to the position designated by the at least one coordinate based on a second regulation of the detected signals; and 3) determining presence of the input operation to the input operation surface based on the determination of the start and the termination of the input operation.

In the input device thus structured, even if the size of the detected signals varies due to other factors other than the actual input operations where operators intentionally perform, it makes possible to effectively determine between the variation of the detected signals due to the actual input operations and the variation of the detected signals due to other factors. Accordingly, it is possible to prevent false detection when determining the presence of input operations.

### BRIEF DESCRIPTION OF THE DRAWINGS

FIG. 1 is a functional block diagram that shows some principal parts of an input device according to an embodiment of the present invention;

FIG. 2 is a top view that schematically shows one example of an input operation surface of the input device according to the embodiment of the present invention;

FIG. 3 is a graph that shows one example of a waveform of the detected signals of a touch sensor in the input device according to the embodiment of the present invention; and

FIG. 4 is a flow chart that shows one example of an input method of the input device according to the embodiment of the present invention.

### DETAILED DESCRIPTION OF THE PREFERRED EMBODIMENTS

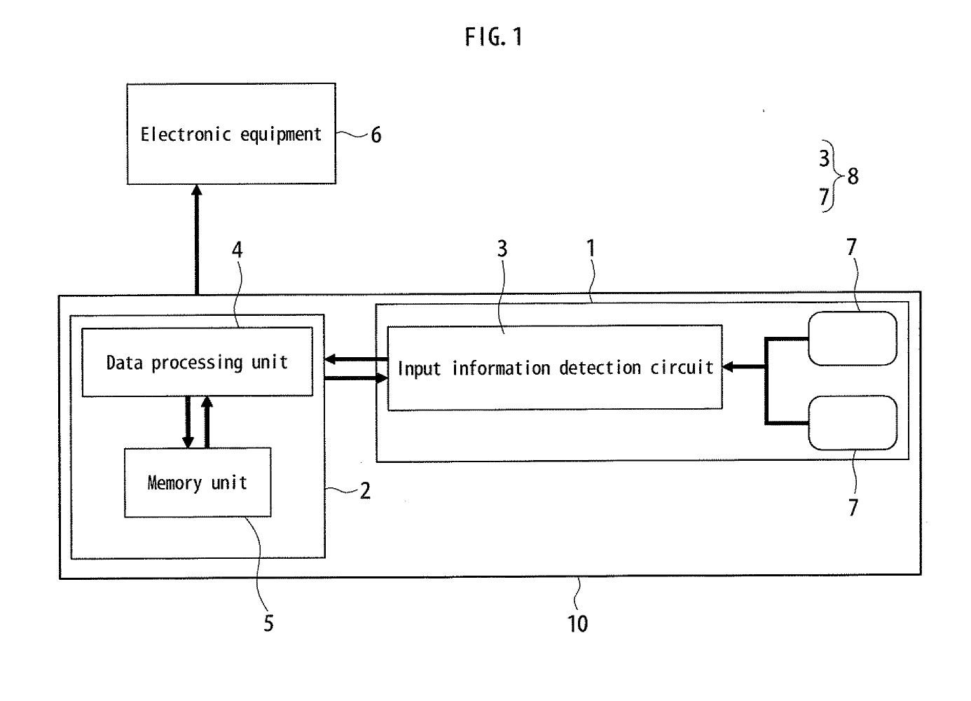

Hereinafter, the embodiments of the present invention will be explained with reference to the accompanying drawings. As shown in FIG. 1, an input device 10 is for an electronic equipment 6, the input device 10 being composed of: an operation unit 1 including an input operation surface (not shown) and a touch sensor 8 that detects the input operations performed on the input operation surface; and a control circuit unit 2 into which the detected signals of the touch sensor 8 output from the operation unit 1 is input.

In the input device 10, the touch sensor 8 is a capacitance touch sensor including a touch pad 7 and an input information detection circuit 3. When operators' fingers, etc. are in contact to, or are near the touch pad 7 functioning as the electrodes of a capacitor, the touch sensor 8 will detect variations of capacitance through the input information detection circuit 3.

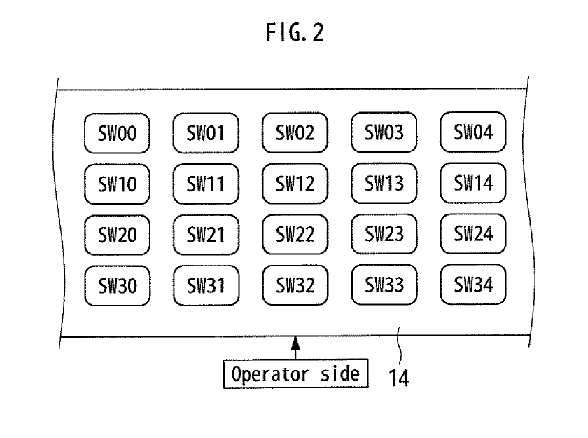

In the input device 10, as schematically shown in FIG. 2, a plurality of panels each corresponding to key switches (SW00 to SW34) is provided on an input operation surface 14. The touch pad 7 is arranged at each of the key switches SW00 to SW34. Each of the touch pads 7 may be provided on a substrate arranged beneath the input operation surface 14 so as to be positioned directly under each of the key switches SW00 to SW34.

Accordingly, in case of the Input device 10, coordinates arranged on the input operation surface 14 specifically denote information that designates each of the key switches (for example, the integer combination of 00 to 34). Further, input operations to each of the coordinates will be thus equal to the input operations to each of the key switches SW00 to SW34.

Operators handling the input device 10 will let their fingers, etc. touch on a position corresponding to each of the key switches SW00 to SW34 arranged on the input operation surface 14. Input operations to each of the key switches can be thus performed. The input information detection circuit 3 then detects variations of capacitance induced by the input operations and generated on the touch pad 7 corresponding to each of the key switches SW00 to SW34. Detected signals corresponding to the detected variations of capacitance are then output to the control circuit unit 2.

In the input device 10, a key switch being subjected to input operations is first determined. Then, the information is output from the control circuit unit 2 to the input information detection circuit 3. The input information detection circuit 3 will then output the information (detected signals corresponding to the key switch subjected to input operations) to the control circuit unit 2. Accordingly, based on the detected information that has been input from the operation unit 1, the control circuit unit 2 will identify the key switch on which the input operations have been performed. However, the present invention is not limited thereto. Instead, considering the detected information that is input from the operation unit 1 to the control circuit unit 2, the input device according to the present invention is optionally structurable as long as the control circuit unit 2 can determine a position (for example, the key switch) on the input operation surface to which input operations have been performed.

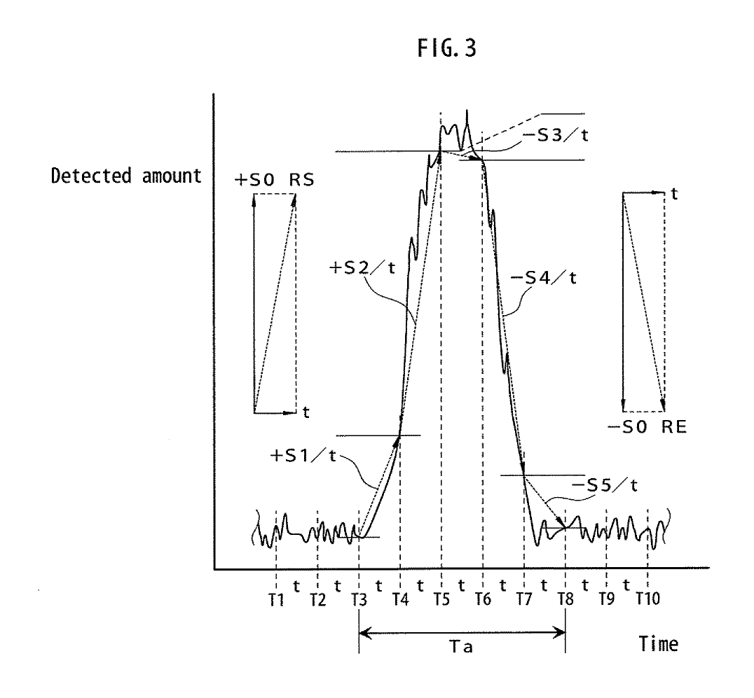

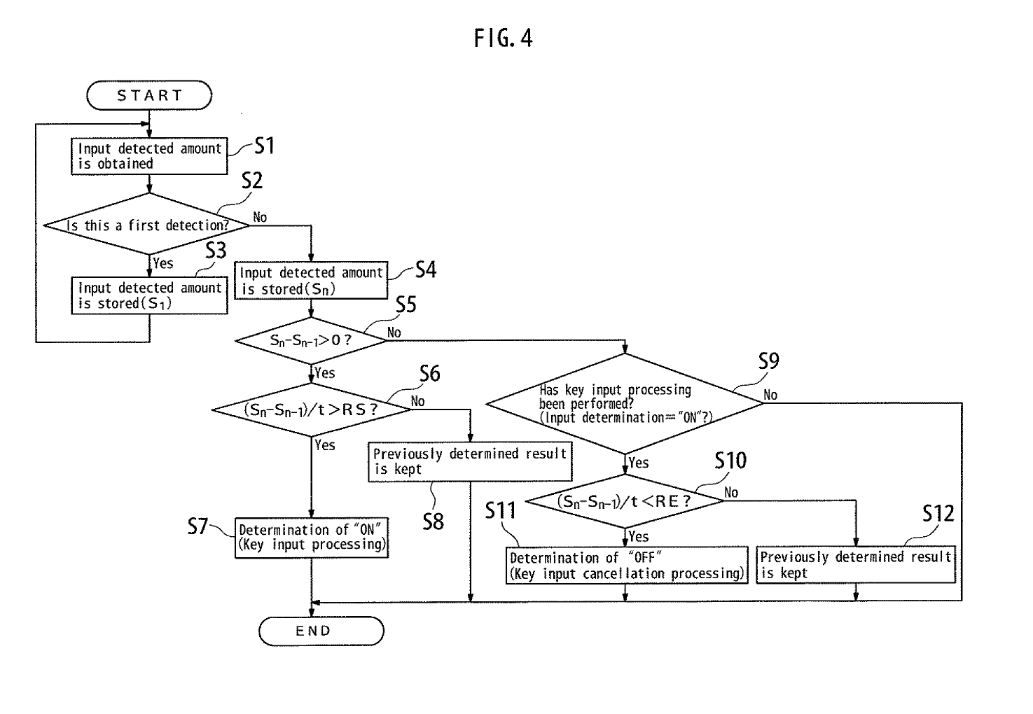

Further, in the input device 10, the control circuit unit 2 includes a memory unit 5 and a data processing unit 4 as a functional block. With reference to FIGS. 3 and 4, each function of the functional blocks as well as the input method of the input device 10 according to the embodiments of the present invention will be explained.

FIG. 3 is a graph that illustrates one example of the detected signal waveforms of the touch sensor 8 in a single key switch. In the control circuit unit 2, the memory unit 5 stores a first reference value RS which is the reference of regulations (a first regulation) of detected signals, the first reference value RS working as a first decision information for detecting the start of input operations to each of the key switches. Further, the memory unit 5 also stores a second reference value RE which is the reference of regulations (a second regulation) of detected signals, the second reference value RE working as a second decision information for detecting the termination of input operations to each of the key switches. Here, in this embodiment, the first regulation is a positive regulation while the second regulation is the one other than the positive regulation (either zero or negative). In this example, the first reference value RS contains positive values (that is, the regulation in the ratio of increased detected values) while the second reference value RE contains negative values (that is, the regulation in the ratio of decreased detected values).

The data processing unit 4 of the control circuit unit 2 is adapted to have samples of the detected signals of the touch sensor 8 at every predetermined time t to each of the key switches. Variations of the detected values at a predetermined time t will then be gathered based on two sample values that have been consecutively obtained. Accordingly, the regulation obtained in the ratio of the variations at the predetermined time t (that is, an average regulation at the predetermined time t) is determined.

To be more specific, based on the example of FIG. 3, at each time defined by T1, T2 . . . T10, detected signals are sampled. Variation of each predetermined time of T1 to T2, T2 to T3, . . . , T9 to T10 (for example, +S1, +S2, −S3, −S4, −S5) as well as an average regulation at each predetermined time t (for example, +S1/t, +S2/t, −S3/t, −S4/t, −S5/t) will be obtained. Here, each variation of S1 to S5 is a positive value. Further, the first reference value RS and the second reference value RE based on the regulation of the detected signals are indicated by RS=+S0/t and RE=−S0/t where each absolute value of the variation of the detected signals are S0.

In the data processing unit 4, the first regulation or the second regulation, which is an average regulation at each predetermined time t obtained as described above, and the first reference value RS or the second reference value RE are compared. In case that the first regulation is determined as being larger than the first reference value RS, the start of the input operation is determined. Subsequently, considering the key switch determined as that input operations have been started, in case that the second regulation is determined as being smaller than the second reference value RE, the input operations are determined as being terminated.

Here, FIG. 3 illustrates a certain range starting from a condition where input operations to key switches are not yet performed (that is, 1) power is applied to the input device 10, but input operations to a key switch has not yet been performed, or 2) immediately preceding input operations have been just completed). In this condition, average regulations at each predetermined time of T1 to T2 and T2 to T3 are compared to the first reference value RS or the second reference value RE depending on either the average regulations are positive or negative. The average regulations become either smaller than the first reference value RS or larger than the second reference value RE. Accordingly, at the time of T2 and T3, it is determined as that there has been no input operation to any of the key switches (the OFF condition). The average regulations (the first regulation)+S1/t at the predetermined time of T3 to T4 are compared to the first reference value RS. Since the first regulation is smaller than the first reference value RS (+S1/t<+S0/t), it is determined as that there has been no input operation to the key switches (the OFF condition).

Next, the average regulations (the first regulation)+S2/t at the predetermined time of T4 to T5 are again compared to the first reference value RS. Since the first regulation is larger than the first reference value RS (+S2/t+S0/t), it is determined as that input operations to a key switch start (transition from the OFF condition to the ON condition).

Having determined the start of input operations, the average regulations (the second regulation) −S3/t at the predetermined time of T5 to T6 are compared to the second reference value RE. Since the second regulation is larger than the second reference value RE (−S3/t>−S0/t), it is determined as that there have been input operations to a key switch at the time of T6 (the ON condition). Next, the average regulations (the second regulation) −S4/t at the predetermined time of T6 to T7 are again compared to the second reference value RE. Since the second regulation is smaller than the second reference value RE (−S4/t<−S0/t), it is determined as that input operations to a key switch terminates at the time of T7 (transition from the ON condition to the OFF condition). Following the above condition, the average regulations (the second regulation) −S5/t at the predetermined time T7 to T8 are further compared to the second reference value RE. Since the second regulation is larger than the second reference value RE (−S5/t>−S0/t), it is determined as that there have been no input operation to a key switch (the OFF condition). Average regulations at the predetermined times of T8 to T9 and T9 to T10 will be compared to either the first reference value RS or the second reference value RE depending on whether the average regulation is positive or not. Since the average regulation becomes either smaller than the first reference value RS or larger than the second reference value RE, it is determined as that there has been no input operation to a key switch at the times of T9 and T10 (the OFF condition).

Here, in the input device 10, the predetermined time t, which is the sampling interval of the detected signals of the touch sensor 8, possesses a sufficient resolution to detect the actual input operations. The sampling interval is thus set shorter than the normally assumed shortest interval, which is from the start to the termination of a single input operation.

For example, the shortest interval defined between what operators move their fingers down so as to touch the input operation surface 14 and what operators move their fingers up so as to be detached from the input operation surface 14 is normally 20 ms. When the predetermined time t is set to approximately 5 ms, it is allowed to have a sufficient resolution to detect the start and the termination of the actual input operations. As shown in FIG. 3, in case that a period Ta between what operators move their fingers down so as to touch the input operation surface 14 and what operators move their fingers up so as to be detached from the input operation surface 14 is set to 20 ms, the predetermined time t will be 4 ms.

Further in the input device 10, the first reference value RS of the first regulation of detected values is set as that variation where the detected values are enlarged at the predetermined time t due to the first regulation satisfies the following conditions (That is, RS×t. Hereinafter, this may be called a first reference variation when appropriate). To be more specific, in this first reference variation (RS×t), variations to be increased during a predetermined time t at the start of the actual input operations are set to be smaller than the minimum amount normally assumed. In addition, variations to be increased during the predetermined time t of the variation of detected signals to be generated due to factors other than the actual input operations (hereinafter, referred to as the “unnecessary variations” when appropriate) are set to be larger than the maximum value normally assumed.

As the same, considering the second reference value RE of the second regulation of detected values, the absolute value of variations where detected values have been decreased at a predetermined period t in the second regulation (RE×t. hereinafter referred to as a second reference variation when appropriate) is set to 1) a value smaller than the normally assumed minimum amount of the absolute value of variations to be decreased at a predetermined time t at the termination of the actual input operations; and 2) a value larger than the normally assumed maximum amount of the absolute value of variations to be decreased at a predetermined time t of the unnecessary variations.

Here, in the present invention, when setting the first and the second reference values RS and RE, based on a consideration of any unnecessary variations induced by the input device of the present invention, it can be concluded as that the start and the termination of the actual input operations are certainly determinable, contributing to well-decision of the presence of the input operations.

Further, when setting the first and the second reference values RS and RE, among the unnecessary variations to be induced by various factors, mainly the unnecessary variations to be induced at a time scale longer than the time scale of variations of detection signals corresponding to the actual input operations (for example, 20 ms) may be focused (hereinafter referred to as the “long-term unnecessary variations” when appropriate).

Based on the above resolution, a predetermined time t is set to a period shorter than the time scale (for example, 20 ms) of variations of detected signals corresponding to the actual input operations. Accordingly, in case that the unnecessary variations of detected signals are the long-term unnecessary variations, regardless of the size of variations, the absolute value of the average regulation at a predetermined period t will be normally set to be smaller than the absolute value of variations at a predetermined period t at the start and the termination of the actual input operations. It is thus possible to appropriately set the first and the second reference values RS and RE based on such long-term unnecessary variations.

Here, the variation of the detected signals due to environmental changes (deformation occurred on any components due to changes in temperature, humidity, and the like) is generally known as considerably long term changes (that is, moderate changes). On the other hand, the variation of the detected signals induced when operators place their fingers to make contact to the input operation surface 14 or to make near the input operation surface 14 without their intentions (hereinafter referred to as the “unintentional touches”) is generally regarded as a short-term (that is, rapid) variation compared to the unnecessary variations due to environmental changes. However, when compared to the actual input operations, the variation caused by the unintentional touches, etc. is still regarded as long-term variations. Accordingly, in each individual application of the present invention, in consideration of the supposable long-term unnecessary variations, the first reference value RS of the first regulation of the detected signals as well as the second reference value RE of the second regulation of the detected signals are both set. Based on the above, without having any influence of the environmental changes and the unintentional touches, the start and the termination of the actual input operations become well determinable, and consequently the presence of the input operations can be certainly decided.

Here, as to the unnecessary variations induced at a time scale shorter than the time scale of the variation of detected signals corresponding to the actual input operations, for example, high frequency noises (hereinafter referred to as the “short-term unnecessary variations”), average regulations at the predetermined time t of detected signals will be applied to determine the start and the termination of input operations in the input device 10. Most of the unnecessary variations can be thus removed. To be specific, in case that its predetermined time t is set to approximately 5 ms, variations of the detected signals induced at the time scale of less than approximately 1 ms (approximately 1 kHz or more) will be averaged. Accordingly, no significant influence can be found on the average regulation of the variations of the detected signals at the predetermined time t. For example, in the example illustrated in FIG. 3, the average regulation at the predetermined periods of T1 to T2, T2 to T3, T8 to T9 and T9 to T10 becomes nearly 0.

However, when considering a case that a timing at which the data processing unit 4 samples detected signals and a timing at which detected signals have their peak values due to the short-period unnecessary variations are accidentally matched to each other, the absolute value of the average regulation of detected signals at a predetermined time t becomes unusually large. Accordingly, in a comparison between the average regulation and the first and second reference values RS, RE which is set based on the assumed long-term unnecessary variations, it can not completely eliminate possibilities which satisfy a condition to determine that there are the start and the termination of the input operations. This problem however can be prevented by the following means

In the data processing unit 4, when comparing the first regulation and the first reference value RS of detected signals in order to determine the start of input operations, if necessary, in case that a result where the first regulation is larger than the first reference value RS is obtained in multiple times (preferably, in a consecutive manner), the start of input operations to the key switches will be determined. As the same, in the data processing unit 4, when comparing the second regulation and the second reference value RS of detected signals in order to determine the termination of input operations, if necessary, in case that a result where the second regulation is smaller than the second reference value RE is obtained in multiple times (preferably, in a consecutive manner), the termination of input operations to the key switches will be determined.

Based on the above, probabilities to misjudge the start and the termination of input operations due to the short-term unnecessary variations caused by high frequency noises, etc. can be reduced to an extent practically zero. The number of comparative results to be necessary can be properly set according to applications, etc. of the input device 10.

Here, in these multiple comparisons until the start and the termination of input operations are determined, each of the first and the second regulations may be compared to each of the identical first and second reference values RS and RE. On the other hand, the plural numbers of first and second reference values RS and RE different to each other may be stored in the memory unit 5. And, in the multiple comparisons until the start and the termination of input operations are determined, the first and the second reference values RS and RE that are used for the comparison with each of the first and the second regulations may have different values according to rise and fall of detected signal waveforms corresponding to the start and the termination of input operations.

Here, in the input device 10, in order to allow the predetermined time t, the first reference value RS and the second reference value RE to be flexibly set, these data may be stored in the memory unit 5 as the predetermined time t, the first reference variation (RS×t), and the second reference variation (RE×t). FIG. 3 exemplifies that the absolute value of both the first reference variation and the second reference variation are identical, and when the absolute value is set to S0, RS=S0/t and RE=−S0/t are satisfied. However, the absolute value of the first reference value RS of the first regulation of detected signals and the absolute value of the second reference value RE of the second regulation of detected signals may be different to each other. These absolute values may be properly set according to the condition of the input device and the touch sensor of the present invention.

Supposing that the first and the second reference variations of detected signals are each properly set as variations that increase and decrease during a predetermined time t with a regulation identical with the first and the second reference values RS and RE, in case that these data are stored in the memory unit 5 as the predetermined period t, the first reference variation and the second reference variation, there will be no need to divide variation by the predetermined time t. Based on the above, there is no need to say that a comparison between variation at a predetermined period t of detected signals and the first and the second reference variations will definitely mean a comparison between the first regulation and the first reference value RS at a predetermined period t of detected signals, and a comparison between the second regulation and the second reference value RE at a predetermined period t of detected signals.

In the input device 10, the control circuit unit 2 may be composed of a well-known micro computer system that includes a processing unit, a memory, an I/O circuit, and the like. In this ease, as to the memory unit 5 and the data processing unit 4 that are the elements of the control circuit unit 2, as long as the above functions are satisfied, it is possible that an optional hardware, software or the combinations thereof may be applied. Further, in the input device 10, detected signals to be sampled by the data processing unit 4 will be stored in the memory unit 5 as digital data. The variation of detected signals and the first/second regulations, etc. at a predetermined time t may be calculated through operation processing executed by these digital data. Here, these detected signals of the touch sensor 8 will be output from the input information detection circuit 3 as analog data. On the other hand, the data processing unit 4 may obtain sampling data as digital data by means of an A/D converter, etc. installed in the data processing unit 4. In addition, the input information detection circuit 3 may be provided with the A/D converter and may output the detected signals of the touch sensor 8 as digital data.

In the input device 10, in case that the detected signals of the touch sensor 8 is output from the input information detection circuit 3 as analog data, variation of the detected signals, the first/second regulation, etc. at a predetermined time t may be derived by means of an optionally selected analog circuit.

Next, with reference to the flow chart in FIG. 4, one example of input methods of the input device 10 will be explained as input process procedures in connection with the control circuit unit 2 of the input device 10. Here, FIG. 4 illustrates an input process to only a single key switch for clearly explaining features in the present invention. However, when the input device 10 has a plurality of key switches, it is well known in person skilled in the art that the control circuit unit 2 is structurable as follows. The selection of the key switches to be subjected to the input processes of FIG. 4 and the execution of the input processes of FIG. 4 to the key switches are performable at every key switch at a predetermined timing.

After activating the input device 10, or after passing a predetermined time t from an immediately preceding sampling, the data processing unit 4 will sample the detected signals of the touch sensor 8 that have been input from the operation unit 1 to the control circuit unit 2 (Step S1). Then, in Step S2, the data processing unit 4 will determine whether this sampling is the first sampling after activating the input device 10. If the sampling is determined as the first one (Yes), its sampling value (S1) is stored in the memory unit 5. After passing a predetermined time t, Step S1 will be then executed again.

In Step S2, if the sampling is determined as not the first sampling after activating the input device 10 (No), the data processing unit 4 will store the sample value (the sample value Sₙ of n(≧2) times) in the memory unit 5. Here, in the input device 10, at least an immediately preceding sampling value Sₙ₋₁ should be stored in the memory unit 5. Then, in Step S5, the data processing unit 4 will determine whether or not a variation Sₙ−Sₙ₋₁ is positive at a predetermined time t (Sₙ−Sₙ₋₁>0). If the variation Sₙ−Sₙ₋₁ is determined as positive (Yes), at Step S6, the first regulation ((Sₙ−Sₙ₋₁)/t), which is the average regulation of detected signals at a predetermined time t, is determined whether or not the first regulation ((Sₙ−Sₙ₋₁)/t) is larger than the first reference value RS of the first regulation ((Sₙ−Sₙ₋₁)/t>RS).

At Step S6, if the first regulation ((Sₙ−Sₙ₋₁)/t), which is the average regulation of detected signals, is determined as being larger than the first reference value RS of the first regulation (Yes), the data processing unit 4 will determine at Step S7 as that input operations to key switches have been executed (that is, a transition has been occurred from a condition where no input operation is executed (the OFF condition) to a condition where input operation is executed (the ON condition)). The data processing unit 4 will then execute necessary key input operations to complete this procedure. This key input operation includes, for example, that: 1) the input condition of this key switch is stored as the ON condition in the memory unit 5 (updating from the OFF condition to the ON condition); and 2) information (such as Make Key Code) corresponding to the transition to the ON condition of the key switch is output to the electronic equipment 6, and the like. Following these procedures, Step S1 is re-started again after passing a predetermined time t.

At Step S6, if the first regulation ((Sₙ−Sₙ₋₁)/t), which is the average regulation of detected signals, is determined as not being larger than the first reference value RS of the first regulation (No), the data processing unit 4 will maintain the previous result determined (Step S8) and terminate this procedure. At Step S8, the input condition of key switches that has been stored in the memory unit 5 (the ON condition or the OFF condition) will not be updated, and the output of key codes, etc. will not be performed. Following the end of this procedure, Strep S1 will be re-started after passing a predetermined time t.

Further, at Step S5, if the variation Sₙ−Sₙ₋₁ is determined as not positive (No), the data processing unit 4 will refer to, for example, the memory unit 5 at Step S9. The data processing unit 4 will then determine whether or not this key switch is presently in the ON condition. If it is the ON condition (Yes), at Step S10, the data processing unit 4 will determine whether or not the second regulation ((Sₙ−Sₙ₋₁)/t), which is the average regulation of detected signals at a predetermined time t, is smaller than the second reference value RE of the second regulation ((Sₙ−Sₙ₋₁)/t<RE).

At Step S10, if the second regulation ((Sₙ−Sₙ₋₁)/t), which is the average regulation of detected signals, is determined as being smaller than the second reference value RE of the second regulation (YES), the data processing unit 4 will determine, at Step S11, as that input operations that have been performed to this key switch have been cancelled (meaning that the transition has occurred from the ON condition to the OFF condition). The data processing unit 4 will execute necessary processing to cancel key inputs and then terminates these procedures. This key input cancellation processing includes, for example, that: 1) the input condition of this key switch that has been stored in the memory unit 5 is updated from the ON condition to the OFF condition; and 2) information corresponding to the transition to the OFF condition of this key switch (such as Break Key Code) is output to the electronic equipment 6, and the like. Following the end of this procedure, Step S1 will re-start after passing a predetermined time t.

At Step S10, if the second regulation ((Sₙ−Sₙ₋₁)/t), which is the average regulation of detected signals, is determined as not being smaller than the second reference value RE of the second regulation (No), the data processing unit 4 will retain the previous result determined (Step S12). The data processing unit 4 will then terminate this procedure. At Step S12, the input operations of key switches that have been stored in the memory unit 5 (the “ON condition”) will not be updated, and the output of key codes, etc. will not be performed. Following the end of this procedure, Step S1 will re-start after passing a predetermined time t. Further, at Step S9, if this key switch is not presently in the ON condition (NO), the data processing unit 4 will terminate this procedure. Then, after a predetermined time t is passed, Step S1 will re-start.

Here, in the input processing procedure shown in FIG. 4, in order to execute the processing of Steps S5, S6 and S10, current sampling values Sₙ and immediately preceding sampling values Sₙ₋₁ may be both stored in the memory unit 5 of the control circuit unit 2. Or, only the immediately preceding sampling values Sₙ₋₁ may be stored in the memory unit 5 of the control circuit unit 2, and the current sampling values Sₙ may be stored in the memory unit 5 after executing necessary computing processing. On the other hand, the input information detection circuit 3 of the touch sensor 8 may be provided with another memory unit (not shown). It is thus possible to conduct computing processing between the immediately preceding sampling values Sₙ₋₁ that have been stored in the memory unit 5 of the control circuit unit 2 and the current sampling values Sₙ that have been stored in the another memory unit (not shown) of the input information detection circuit 3.

Further, in the input processing procedure shown in FIG. 4, at Step S5, the regulation Sₙ−Sₙ₋₁ is determined whether or not it is positive. Accordingly, in each comparison of Steps S6 and S10, the absolute value of the average regulation (Sₙ−Sₙ₋₁)/t may be compared by determining whether or not the absolute value of the average regulation (Sₙ−Sₙ₋₁)/t is larger than the absolute value of the first and second reference values of RS, RE. Still further, at Step S9, when determining whether or not key switches are presently in the ON condition, it is possible to determine based on the size of the current sampling values Sₙ of detected signals.

In input processing procedure shown in FIG. 4, in case that a result with satisfied conditions (Yes) has been obtained by comparing Steps. S6 with S10, the number of times of the result is stored in the memory unit 5, and the Steps are each moved to Steps S8 and S12. As a result of repeating the input processing procedure to re-start Step S1, and in case that the number of times to be stored in the memory unit 5 is matched to some certain number of times set in advance, Steps S7 and S11 may be each executed. Moreover, a comparison processing at Steps S6 and S10 may be each executed based on a comparison between variation Sₙ−Sₙ₋₁ and the first reference variation (RS×t) or the second reference variation (RE×t).

Information outputs to the electronic equipment 6 are not limited to cases that are executed at 1) the key input processing at Step S7; and 2) the key input cancellation processing at Step S11. Instead, the information outputs to the electronic equipment 6 may be executed when obtaining a pair of information, which is composed of 1) information corresponding to a transition to the ON condition and 2) information corresponding to a transition to the OFF condition.

In the input device 10 that is structured as described hereinabove, even if the size of detected signals varies due to factors other than the actual input operations, the variation of detected signals due to the actual input operations and the variation of detected signals due to other various factors can be effectively determined with simple and cost-effective structures without using additional circuit elements. Accordingly, false detections when determining the presence of the input operations will be well preventable.

Further, in the input device 10, since operators are allowed to take the stand-by position, operationabilities of keyboard devices for a personal computer which uses a touch sensor can be notably improved.

Still further, in the input device 10, since the presence of the input operations to each of the key switches is determined based on the regulations of detected signals when the input operation starts and terminates, even if operators perform the long-pressed condition, it will not influence the correct determination of whether or not the input operations to the key switches should be terminated. Accordingly, the detection of the ON and OFF conditions can be certainly made during the long-pressed condition of the key switches.

Here, in the input device 10 as described hereinabove, the absolute values of the first and second reference values RS, RE to each of the key switches may be configured to be all identical. On the other hand, in order to further improve its operationability, other appropriate values are addable depending on the arrangement of the key switches (to improve operationability of operators) or functions allocated to the key switches (together with detection sensibilities necessitated to satisfy the functions), and the like.

Moreover, the control circuit unit 2 installed in the input device 10 is configured as that the first and second reference values RS, RE to each of the key switches are adjustable either evenly to all of the key switches or separately to each of the key switches. When the data processing unit 4 has determined that input operations to any one of the key switches or to the plurality of key switches have been started, the first reference value RS may be reset to be updated either evenly to all of the key switches or separately to each key switch according to the size of the average regulation of detected signals used to decide the determination. Further, in case that the determination of terminating input operations to any one of or a plurality of key switches is decided, according to the size of the average regulation used to decide the determination, the second reference value RE may perform either one of the following or both of the following: 1) resetting to update all of the key switches evenly, or 2) resetting to update each key switch separately.

Accordingly, during the operation of the input device 10, the detection sensibility of the actual input operations and the distinction precision against the unnecessary variation of the detected signals can be constantly kept in an appropriate condition.

Here, the above examples will be explained with reference to FIGS. 3 and 4. In case that the actual input operations have been performed to the key switches, it is shown as that the detected amount of the detected signals is increased. In this case, the positive/negative codes of the first and second reference values RS, RE, comparative conditions using these positive and negative codes, and the like are properly replaceable. Accordingly, in the input device 10, in case that the actual input operations to key switches have been performed, the same should be applicable also in a case where the detected amount of detected signals decrease.

The preferable embodiments of the present invention have been explained. The present invention is however not limited thereto. Instead, for example, the input device of the present invention may be composed of a capacitance-type touch sensor 8 allowed to continuously detect the position of input operations on the input operation surface 14. Here, a specific position (or a specific range) to which input operations are applied may be defined based on data corresponding to values (or the range of values) actually readable from optional two-dimensional coordinates provided along the input operation surface 14.

Here, the touch sensor of the input device according to the present invention is not necessarily to be the capacitance-type touch sensor. Instead, a sensor, which is allowed to detect the variations of optional physical qualities such as temperatures, loads, vibrations or luminous energies, and which is allowed to output these variations as detected signals, can be applied.

In addition, in the input device of the present invention, the control circuit unit 2 may be provided with a truth-or-error detection means. In this truth-or-error detection means, as to the ON condition determined based on the first reference value RS, the following can be determined by using information such as the arrangement of each of the key switches, the size of detected signals of the touch sensor 8, and the like: 1) the ON condition that has been determined as input operations but not based on the intention of operators is error; and 2) the ON condition that has been determined as input operations which is based on the intention of operators is truth. In this case, key input processing performed by Step S7 shown in FIG. 4 should be executed only when the truth-or-error detection means determines as truth.

As explained hereinabove, the input device according to the present invention can be most effectively applied to key board devices for a personal computer where operators perform input operations at a high speed to each coordinate with their fingers. However, the input device according to the present invention is not limited thereto. Instead, the present invention is applicable to any optional input device for electronic equipments such as controllers for game devices, controllers for portable communications, operation panels for any electronic equipments, remote controllers for any electronic equipment, and the like.

1. An input device for an electronic equipment, the input device being composed of: an input operation surface; an operation unit including a touch sensor that detects input operation on the input operation surface; and a control circuit unit to which detected signals output from the touch sensor arranged in the operation unit are input,
wherein the input operation surface has at least one coordinate thereon; the control circuit unit includes a first decision information that decides a start of the input operation to a position designated by the coordinate based on a first regulation of the detected signals; the control circuit unit also includes a second decision information that decides a termination of the input operation to a position designated by the coordinate based on a second regulation of the detected signals; and presence of the input operation to the input operation surface is determined based on the decision of the start and the termination of the input operation.

2. An input device according to claim 1, wherein the first decision information includes a first reference value of the first regulation;
the second decision information includes a second reference value of the second regulation; and
the control circuit unit is composed of a memory unit that stores the first and the second reference values to each of the at least one coordinate, and a data processing unit that determines presence of the input operation at each coordinate, the data processing unit being configured to work as follows:
1) both the first regulation and the second regulation are applied to determine as an average regulation at a predetermined time of the detected signals that have been input to the control circuit unit;
2) the first reference value to the coordinate corresponding to the detected signals is compared with the first regulation, and when a result that is determinable as the start of the input operation is obtained at least one time based on the comparison, decision, in which the input operation to a position designated by the coordinate starts, is determined; and
3) the second reference value and the second regulation of the coordinate corresponding to the detected signals are compared to each other, and when a result that is determinable as the termination of the input operation is obtained at least one time based on the comparison, decision, in which the input operation to a position designated by the coordinate terminates, is determined.

3. An input device according to claim 2, wherein the control circuit unit performs the following operation to each of the at least one coordinate arranged on the input operation surface:
1) from a decision where the input operation to the coordinate starts to a decision where the input operation to the coordinate terminates, the input operation to the coordinate is determined as being present; and
2) from a decision where the input operation to the coordinate terminates to a decision where the input operation to the coordinate starts, the input operation to the coordinate is determined as being not present.

4. An input device according to claim 2, wherein the control circuit unit is configured as that the first and the second reference values to the at least one coordinate provided on the input operation surface are allowed to be set to the whole coordinate uniformly or to each coordinate individually, and the data processing unit performs at least one of the following operation:
1) when determining that an input operation to at least one of the coordinates has started, the first reference value is reset so as to update the whole coordinate uniformly or each coordinate individually according to a size of the first regulation of the detected signals based on the determination; and
2) when determining that an input operation to at least one of the coordinates has terminated, the second reference value is reset so as to update the whole coordinate uniformly or each coordinate individually according to a size of the second regulation of the detected signals based on the determination.

5. An input method of an input device for an electronic equipment, the input device being composed of: an input operation surface; an operation unit including a touch sensor that detects input operation to the input operation surface; and a control circuit unit to which detected signals of the touch sensor in the operation unit is input, the input method comprising the following step in each of at least one coordinate arranged on the input operation surface:
1) determining a start of an input operation to a position designated by the at least one coordinate arranged on the input operation surface based on a first regulation of the detected signals;
2) determining a termination of the input operation to the position designated by the at least one coordinate based on a second regulation of the detected signals; and
3) determining presence of the input operation to the input operation surface based on the determination of the start and the termination of the input operation.

6. An input device according to claim 3, wherein the control circuit unit is configured as that the first and the second reference values to the at least one coordinate provided on the input operation surface are allowed to be set to the whole coordinate uniformly or to each coordinate individually, and the data processing unit performs at least one of the following operation:
1) when determining that an input operation to at least one of the coordinates has started, the first reference value is reset so as to update the whole coordinate uniformly or each coordinate individually according to a size of the first regulation of the detected signals based on the determination; and
2) when determining that an input operation to at least one of the coordinates has terminated, the second reference value is reset so as to update the whole coordinate uniformly or each coordinate individually according to a size of the second regulation of the detected signals based on the determination.
